(19) United States
(12) Patent Application Publication
(10) Pub. No.: US 2025/0113001 A1
(43) Pub. Date: Apr. 3, 2025

(54) IMAGE PROCESSING APPARATUS, CONTROL METHOD, AND STORAGE MEDIUM

(71) Applicant: CANON KABUSHIKI KAISHA, Tokyo (JP)

(72) Inventor: Masaki Kawanishi, Kanagawa (JP)

(21) Appl. No.: 18/890,819

(22) Filed: Sep. 20, 2024

(30) Foreign Application Priority Data
Sep. 29, 2023 (JP) 2023-169556

(51) Int. Cl. H04N 1/00

(52) U.S. Cl. CPC H04N 1/00482; H04N 1/00427; H04N 1/00517

(57) ABSTRACT

Provided is an image processing apparatus in which paper information is registrable, including: a setting unit that sets predetermined information in the paper information; and a registration unit that registers the paper information. In a case where an operation capable of duplicating the paper information and registering new paper information is accepted and a name of the paper information is changed, the registration unit sets the predetermined information in the new paper information and registers the new paper information based on the fact that the predetermined information is set in the paper information.

### BACKGROUND OF THE INVENTION

### Field of the Invention

The present disclosure relates to an image processing apparatus, a control method, and a storage medium.

### Description of the Related Art

Japanese Patent Laid-Open No. 2002-029120 discloses a conventional image processing apparatus in which printing conditions corresponding to respective paper types are registered at the time of shipping (hereinafter referred to as Document 1). This image processing apparatus has a function of having its user select a printing condition corresponding to the type of paper set on a paper feed tray from among the registered printing conditions. Incidentally, the number of types of paper to be used with image processing apparatuses have increased in recent years. Thus, it is possible that a user registers a printing condition that is different from any of the printing conditions registered at the time of shipping.

Also, Japanese Patent Laid-Open No. 2020-012940 discloses an image processing apparatus in which the above-mentioned printing conditions are registered as paper profiles for each individual paper (hereinafter referred to as Document 2). The paper profiles include the type of the paper, for example. This image processing apparatus measures a physical property value of a paper, such as the paper thickness of the paper, for example, with a medium sensor. The physical property value of the paper thus measured is used to search for the corresponding paper profile out of the multiple paper profiles.

In a conventional technique as disclosed in Document 1, in a case of newly registering a printing condition that is different from any of the printing conditions registered at the time of shipping, a printing condition is edited on a host computer connected to the image processing apparatus. After that editing work, the content of the editing work is sent to the image processing apparatus from the host computer, and registration work is performed on the image processing apparatus. As a result, a new printing condition is individually registered for a paper in the image processing apparatus. Thus, the number of printing conditions registered increases as the number of paper types increases. In recent years, the number of printing conditions registered has increased. Thus, searching for a printing condition corresponding to a paper to be used out of the registered printing conditions may take time and effort and lower user-friendliness.

On the other hand, in a conventional technique as disclosed in Document 2, a physical property value of a paper is measured with a medium sensor, this measurement result is registered as a paper profile. Such work is individually performed for each paper profile. Also, in recent years, the number of paper types that are to be used and differ attribute have increased, and the number of paper profiles to be registered have become larger and larger. Thus, searching for a paper profile corresponding to a paper to be used out of the registered paper profiles may also take time and effort and lower user-friendliness.

### SUMMARY OF THE INVENTION

An image processing apparatus according to an aspect of the present disclosure is an image processing apparatus in which paper information is registrable, including: a memory; and a processor connected to the memory, wherein the processor sets predetermined information in the paper information, registers the paper information, and in the registration of the paper information, in a case where an operation capable of duplicating the paper information and registering new paper information is accepted and a name of the paper information is changed, sets the predetermined information in the new paper information and registers the new paper information based on the fact that the predetermined information is set in the paper information.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration of an image processing system;

FIG. 2 is a diagram illustrating an example of the hardware configuration of an image processing apparatus;

FIG. 3 is a diagram illustrating an example of the software configuration of the image processing apparatus;

FIGS. 4A and 4B are diagrams illustrating an example of a screen in a management-setting mode displayed on an operation unit;

FIG. 5 is a diagram illustrating an example of a screen in an editing mode displayed on the operation unit;

FIG. 6 is a diagram illustrating an example of a screen in a name editing mode displayed on the operation unit;

FIG. 7 is a diagram illustrating an example of a screen in a type editing mode displayed on the operation unit;

FIG. 8 is a flowchart illustrating an example of a process of editing paper information and registering a favorite;

FIG. 9 is a flowchart illustrating an example of a process of editing paper information and registering a favorite; and

FIGS. 10A to 10C are diagrams illustrating examples of a screen in a notification mode displayed on the operation unit.

### DESCRIPTION OF THE EMBODIMENTS

Hereinafter, preferred embodiments of the present disclosure will be described in detail in reference to the accompanying drawings. The following embodiments are not intended to limit the matters disclosed herein. In addition, all the combinations of features described in the following embodiments are not necessarily essential for the solution of the present disclosure. Herein, the same constituent elements will be designated with the same reference sign.

### First Embodiment

### System Configuration

### Configuration for Connecting to Server Personal Computer (PC) 101

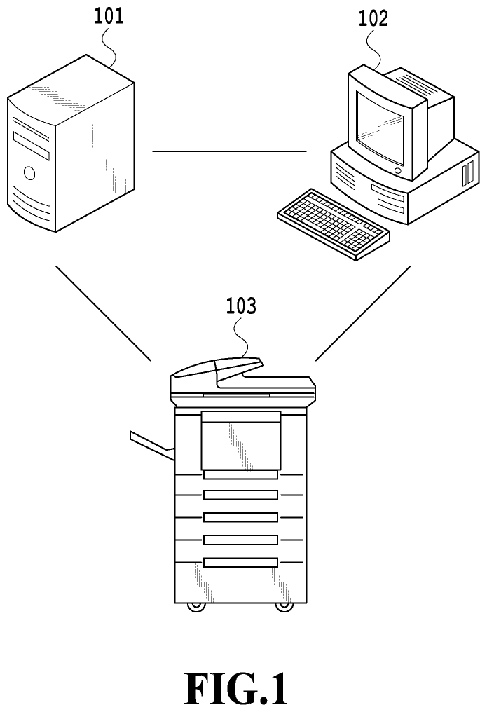

FIG. 1 is a diagram illustrating an example of a system configuration of an image processing system. The image processing system includes a server PC 101, a client PC 102, and an image processing apparatus 103. The server PC 101 (referred to also as the information processing apparatus 101) may be a stationary computer. The server PC 101 has the function of any of various servers such as a file server, for example. The server PC 101 is connectable to each of the client PC 102 and the image processing apparatus 103 through a wired medium or a wireless medium. The server PC 101 is capable of exchanging various signals with the client PC 102 after establishing communication with the client PC 102 through the wired medium or the wireless medium. Similarly, the server PC 101 is capable of exchanging various signals with the image processing apparatus 103 after establishing communication with the image processing apparatus 103 through the wired medium or the wireless medium.

### Configuration for Connecting to Client PC 102

The client PC 102 (referred to also as the information processing apparatus 102) may be a stationary computer. The client PC 102 is connectable to each of the server PC 101 and the image processing apparatus 103 through a wired medium or a wireless medium. The client PC 102 is capable of exchanging various signals with the server PC 101 after establishing communication with the server PC 101 through the wired medium or the wireless medium. Similarly, the client PC 102 is capable of exchanging various signals with the image processing apparatus 103 after establishing communication with the image processing apparatus 103 through the wired medium or the wireless medium.

### Configuration for Connecting to Image Processing Apparatus 103

The image processing apparatus 103 is connectable to each of the server PC 101 and the client PC 102 through a wired medium or a wireless medium. The image processing apparatus 103 is capable of exchanging various signals with the server PC 101 after establishing communication with the server PC 101 through the wired medium or the wireless medium. Similarly, the image processing apparatus 103 is capable of exchanging various signals with the client PC 102 after establishing communication with the client PC 102 through the wired medium or the wireless medium.

### Medium Types

Examples of the wired media include an optical fiber cable, a twisted pair cable, and a coaxial cable. Also, examples of communication standards that use such a wired medium, such as Ethernet (registered trademark), include IEEE 802.3. Examples of the wireless media include electromagnetic waves. Examples of communication standards that use such a wireless medium include IEEE 802.11, IEEE 802.15.1, and the like.

### Generation Description of Image Processing Apparatus 103

The image processing apparatus 103 is a multifunction copier (MFP: Multifunction Peripheral). The image processing apparatus 103 has a function of copying an image formed on a print medium, such as a paper document (referred to also as “paper”), for example. The image processing apparatus 103 has a function of forming and printing print data on a print medium. The print data is sent from the outside of the image processing apparatus 103. For example, the print data is sent from a printer driver outside the image processing apparatus 103. Also, the printing method of the image processing apparatus 103 may be an electrophotographic or inkjet method, or another method. Examples of the other method include a thermal transfer method.

The image processing apparatus 103 may have a function of forming image data by reading an image formed on a print medium, and sending that image data to the outside (referred to also as “send function”). The destination to send the image data is an external file server or a sending destination designated by a mail address. Examples of the external file server include, but are not limited to, a file server implemented by the functions of the server PC 101. The external file server may be a server not illustrated. The image processing apparatus 103 may have a function of sending various pieces of data to an image processing apparatus other than the image processing apparatus 103 and performing printing with the other image processing apparatus to which the data are sent (referred to also as “remote copying function” or “facsimile function”).

### Other Network Configurations

Note that the server PC 101 and the client PC 102 may both be configured as a single computer. For example, a single computer may have a server module that implements the function of the server PC 101 and a client module that implements the function of the client PC 102. Alternatively, the image processing apparatus 103 may be equipped with a server module that implements the function of the server PC 101 and a client module that implements the function of the client PC 102, and only the image processing apparatus 103 may be included. Alternatively, the information processing apparatus 102 as the client PC 102 does not need to be a stationary computer. For example, the information processing apparatus 102 as the client PC 102 may be a tablet computer, a laptop computer, or a smartphone.

### Hardware Configuration of Image Processing Apparatus 103

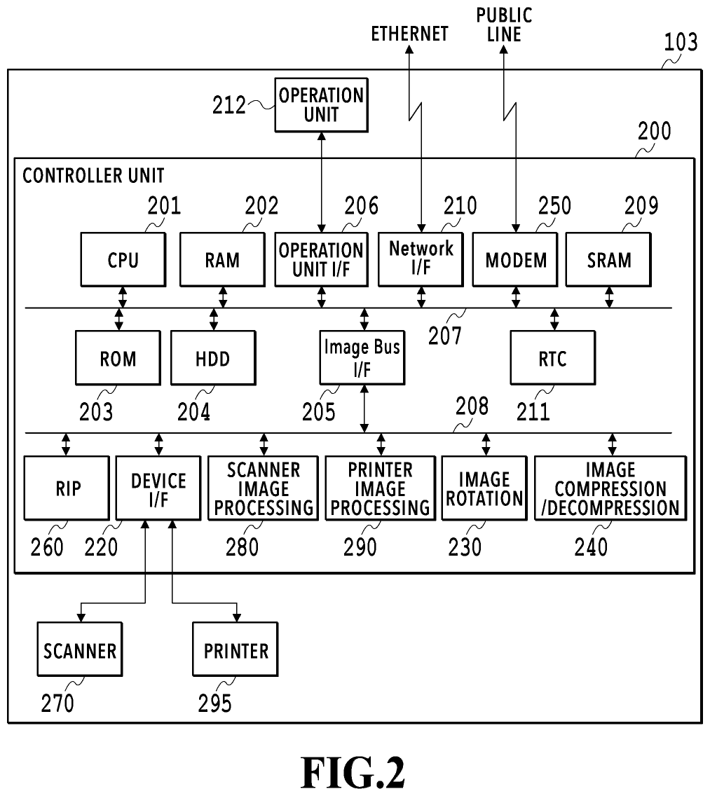

FIG. 2 is a diagram illustrating an example of the hardware configuration of the image processing apparatus 103. The image processing apparatus 103 includes a controller unit 200, an operation unit 212, a scanner 270, and a printer 295. The scanner 270 is a device into which images are input. The printer 295 is a device which outputs images. The controller unit 200 connects to at least one of the scanner 270 and the printer 295. The controller unit 200 connects to the operation unit 212. The controller unit 200 connects to an Ethernet network or a public line. With such a connection configuration, the controller unit 200 receives and outputs image information or device information. Alternatively, the controller unit 200 controls at least one of the scanner 270 and the printer 295 based on the content of an operation on the operation unit 212. Alternatively, the controller unit 200 may be remotely controlled through at least one of the Ethernet network and the public line. A specific description will now be given below.

The operation unit 212 has a configuration to accept operations by the user (referred to also as “present system user”), and a configuration to display various contents. Specifically, the operation unit 212 has a display screen that displays various contents, and hardware keys that accept operations by the user. The display screen is, for example, a liquid crystal display but is not particularly limited to this. The display screen may be an organic electro-luminescence (EL) display. Alternatively, the display screen may be a light emitting diode (LED) display. The configuration to accept operations by the user does not need to be hardware keys, and may be a touch panel. In this case, the configuration may be such that hardware keys and a touch panel are disposed adjacently and can be used in combination with each other. The touch panel may be placed over any of various types of displays, such as a liquid crystal display, in its thickness direction to be configured as a touch panel display, for example.

Note that “operation” is not particularly limited as long as it is an action to convey the user's intention to the present system. For example, in a situation where the user operates a hardware key, the operation refers to pressing (selecting) the hardware key. Also, in a situation where the user operates the touch panel, for example, the operation refers to touching the touch panel. Also, in a case where the user clicks on a predetermined portion of a screen with a device such as a mouse, for example, an operation refers to clicking on a desired portion.

The controller unit 200 has a system bus 207 and an image bus 208. Multiple devices are arranged on each the system bus 207 and the image bus 208. The image bus 208 is capable of transferring image data at high speed. The image bus 208 is a peripheral component interconnect (PCI) bus, for example. The image bus 208 may be an IEEE 1394 bus. Here, the IEEE 1394 bus is a serial bus complying with the IEEE 1394 standard. An image bus I/F 205 is arranged between the system bus 207 and the image bus 208. The image bus I/F 205 connects the system bus 207 and the image bus 208 to each other. The image bus I/F 205 is a bus bridge that converts the data structure of data flowing through the system bus 207 into the data structure of data flowing through the image bus 208 and vice versa.

### Devices Under System Bus 207

First, the devices connected to the system bus 207 will be described. A central processing unit (CPU) 201, a random access memory (RAM) 202, and a read only memory (ROM) 203 are connected to the system bus 207. A hard disc drive (HDD) 204, an operation unit I/F 206, a network I/F 210, and a modem 250 are connected to the system bus 207. A static random access memory (SRAM) 209 and a real time clock (RTC) 211 are connected to the system bus 207.

The CPU 201 is a controller that controls the image processing apparatus 103. The CPU 201 performs various types of control through the system bus 207. The ROM 203 is a non-volatile memory. The ROM 203 stores a system boot program. The ROM 203 functions as a boot ROM in response to launching the system boot program. The RAM 202 is a volatile memory. The RAM 202 functions as a system work memory for operation of the CPU 201. Alternatively, the RAM 202 may function as an image memory to temporarily store image data. That is, programs such as an operating system, system software, and application software and various pieces of data to be referred to in a case of executing programs are loaded to the RAM 202 as appropriate. Note that the CPU 201 loads what is stored in the HDD 204 to the RAM 202 as appropriate. The HDD 204 stores the programs such as the operating system, the system software, and the application software and image data. However, the location to store various pieces of data is not limited to the HDD 204. For example, another storage device, such as a solid state drive (SSD), a Secure Digital (SD) card, or an embedded multi-media card (eMMC), may be used. Alternatively, the CPU 201 may take in what is stored in a removable semiconductor memory, such as a universal serial bus (USB) memory, through an interface unit not illustrated and load it to the RAM 202.

The operation unit I/F 206 is an interface with the operation unit 212. The operation unit I/F 206 has a function of outputting, for example, image data to the operation unit 212 as information to be displayed on the operation unit 212. Alternatively, the operation unit I/F 206 has a function of accepting information input through the operation unit 212 by the present system user and sending it to the CPU 201. The network I/F 210 is an interface with an Ethernet network. The network I/F 210 connects to the Ethernet network, which is a wired medium, and receives and outputs various pieces of information from and to the information processing apparatuses 101 and 102 connected to the Ethernet network. The modem 250 is a device that converts a digital signal in the image processing apparatus 103 into an analog signal for a public line, such as a telephone line, and vice versa. With the modem 250, the image processing apparatus 103 receives and outputs various pieces of information include image information from and to the public line. Incidentally, while illustration is omitted, an optical network unit (ONU) may be connected to the system bus 207. The ONU is an optical line terminating device which converts an electrical signal onto an optical signal. With this ONU, the image processing apparatus 103 can receive and output various pieces of information including image information from and to an optical line. The SRAM 209 is a non-volatile storage medium capable of operating at high speed. The SRAM 209 is used as cache memory, for example. The RTC 211 is an integrated circuit that manages the system time. The RTC 211 has a primary battery or a secondary battery. In this way, while the main power source is shut down, the RTC 211 is still supplied with electric power from the primary battery or the second battery and can therefore manage the system time. For example, even in a state where the controller unit 200 is not powered on, the RTC 211 can perform a process of continuing counting time.

### Devices Under Image Bus 208

Next, the devices connected to the image bus 208 will be described. A raster image processor (RIP) 260 and a device I/F 220 are connected to the image bus 208. A scanner image processing unit 280, a printer image processing unit 290, an image rotation unit 230, and an image compression-decompression unit 240 are connected to the image bus 208. The RIP 260 is a constituent element that generates raster images (referred to also as “bitmap images”). Specifically, the RIP 260 interprets page description language (PDL) code and rasterizes it into a bitmap image. The device I/F 220 connects to at least one of the scanner 270 and the printer 295, and performs synchronous or asynchronous image data conversion. The scanner image processing unit 280 corrects, processes, and edits input image data. The printer image processing unit 290 performs printer correction, resolution conversion, and the like on output image data to be printed. The image rotation unit 230 rotates image data. The image compression-decompression unit 240 performs a compression-decompression process.

### Software Configuration of Image Processing Apparatus 103

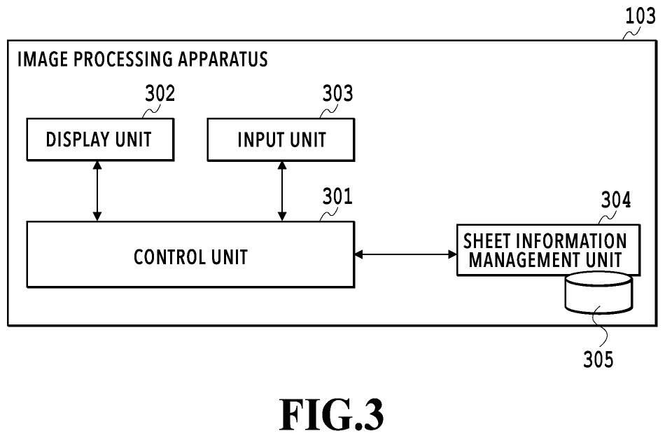

FIG. 3 is a diagram illustrating an example of the software configuration of the image processing apparatus 103. As described above using FIG. 2, based on a program stored in the ROM 203, the CPU 201 implements the functions to be described below and the process in the flowchart to be described later by executing part or the entirety of the program on the RAM 202. A display unit 302 implements a function of displaying the state of the image processing apparatus 103 or an operation menu on the operation unit 212. An input unit 303 implements a function of accepting operations and instructions from the user on the operation unit 212. A paper information management unit 304 implements a function of processing various pieces of information and storing various pieces of information and the like in a paper DB 305 to register the various pieces of information. The paper DB 305 is implemented by the RAM 202 or the HDD 204. For example, of the various pieces of information to be registered in the paper DB 305, a piece of information that is being edited may be loaded to the RAM 202 and a piece of information after being edited may be stored in the HDD 204. As described above, the RAM 202 and the HDD 204 may be differentiated in use as appropriate with the temporal locality and spatial locality of the various pieces of information taken into account. A control unit 301 functions as a logic control entity for the image processing apparatus 103. Specifically, the control unit 301 functions as a control entity for the display unit 302, the input unit 303, and the paper information management unit 304.

### Paper Information

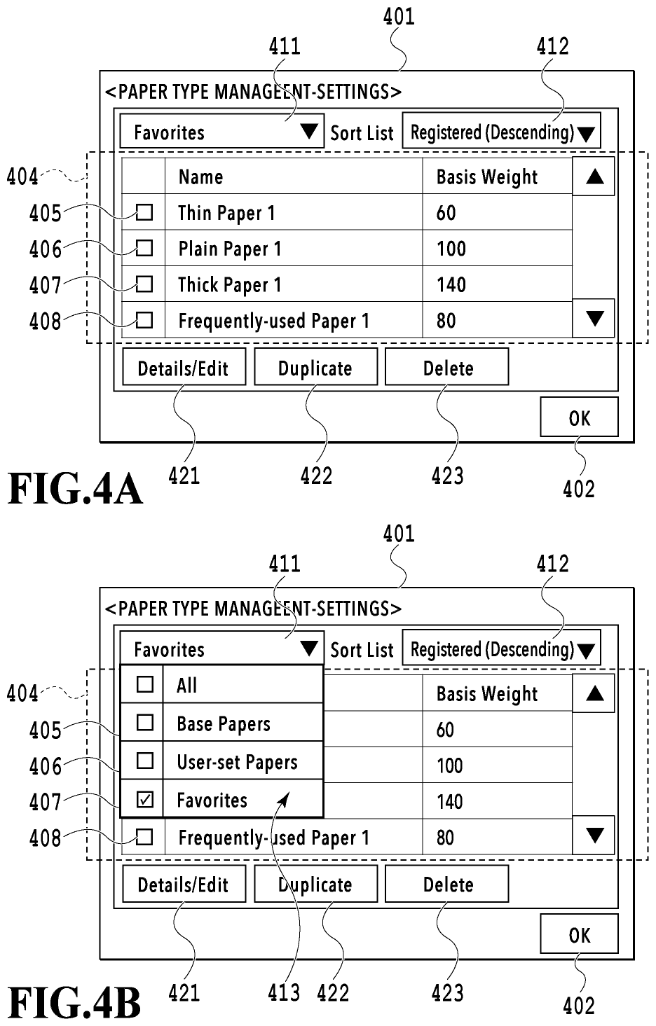

Next, management of paper information by the paper information management unit 304 in FIG. 3 will be described with reference to FIG. 4A to 7. Each of FIGS. 4A to 7 is a diagram illustrating an example of a screen in an operation mode to be displayed on the operation unit 212. Here, an operation mode refers to a mode for managing paper information and is individually provided for each of multiple types of processing contents, as will be described later. FIGS. 4A and 4B are diagrams illustrating an example of a screen in a management-setting mode displayed on the operation unit 212. FIGS. 4A and 4B each illustrate an example in which a management-setting window 401 is displayed in a case where the operation mode is the management-setting mode. The management-setting window 401 includes a paper information list 404. In each of FIGS. 4A and 4B, a paper type selection drop-down list 411 and a sort selection drop-down list 412 are displayed in a region above the paper information list 404. The paper type selection drop-down list 411 is a list to be used to select the type of paper to be displayed. The sort selection drop-down list 412 is a list to sort the contents to be displayed in the paper information list 404. Examples of the sorting method include ascending order and descending order, for example, both of which are registered in the paper DB 305. Here, the management-setting window 401 may be displayed full-screen on the operation unit 212 or displayed in a reduced size on a portion of the screen of the operation unit 212. Alternatively, the size of the management-setting window 401 may be made logically larger than the screen of the operation unit 212, and a portion of the management-setting window 401 may be displayed on the screen of the operation unit 212. In the following, this applies also to the other windows.

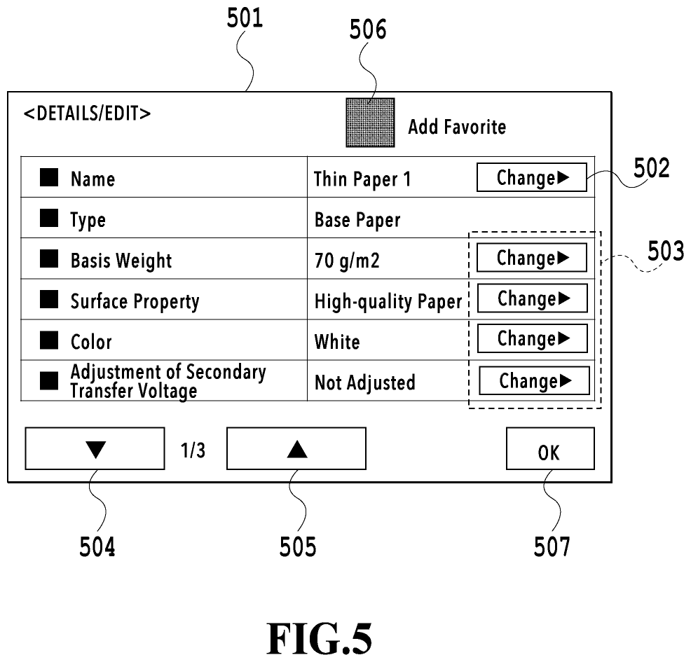

In a case where the paper type selection drop-down list 411 in FIG. 4A is selected, options 413 in FIG. 4B are displayed. In the example of FIG. 4B, four options of “All”, “Base Papers”, “User-set Papers” and “Favorites” are displayed as the options 413. Selecting “All” will display all paper types registered in the paper DB 305 in FIG. 3 in the paper information list 404. Selecting “Base Papers” (referred to also as “base information”) will display base papers in the paper information list 404. The base papers will be described later. Selecting “User-set Papers” (referred to also as “user-set information”) will display user-set papers in the paper information list 404. The user-set papers will be described later. Selecting “Favorites” (referred to also as “favorite information”) will display pieces of paper information registered as favorites in the paper information list 404. Some base papers are registered as favorites by default in advance at the time of shipping the product. Also, favorites can be set with an add favorite button 506 to be described later using FIG. 5. In this case, the favorites are each set by paper type. That is, a favorite represents an indicator set by paper type, and is information set as paper information to facilitate the user's selection, for example. For example, papers corresponding to the base papers are each managed with a paper ID assigned to the paper. Papers corresponding the user-set papers are each managed with a paper ID assigned to the paper. The favorites are set from among the base papers and the user-set papers and therefore managed by obtaining their paper IDs. Specifically, a base paper management list and a user-set paper management list each hold paper IDs for managing the papers. Specifically, a favorite management list may be formed by obtaining the paper IDs corresponding to the favorites from the base paper management list and the user-set paper management list and adding them to the favorite management list. Note that each paper ID is managed in association with paper information in the paper information management unit 304. Thus, by obtaining a paper ID, the paper information corresponding to that paper ID can be obtained.

In FIG. 4A, the paper information list 404 includes pieces of paper information 405 to 408. Here, “paper information” may refer to a piece or pieces of paper information not being particular one or ones of the pieces of paper information 405 to 408 and including a piece or pieces of paper information other than the pieces of paper information 405 to 408. Note that the pieces of paper information 405 to 408 are illustrated in the example of FIG. 4A, but the paper information is not limited to these. For example, in a case where the number of items as the pieces of information displayed in the paper information list 404 exceeds the maximum number of items to be displayed, a scrollbar may be displayed at the right end of the paper information list 404. In a case where this scrollbar can be operated, the paper information list 404 includes a piece or pieces of paper information that can be displayed in addition to the pieces of paper information 405 to 408.

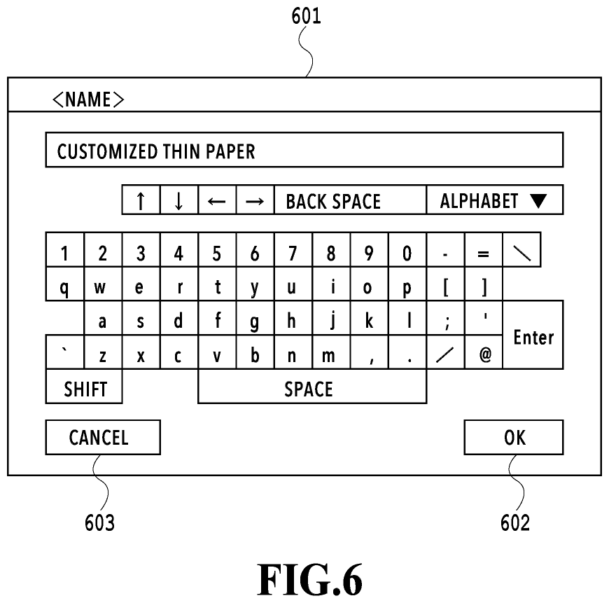

In a region under the paper information list 404, a details/edit button 421, a duplicate button 422, and a delete button 423 are displayed in this order from the left to the right of sheet surface. The details/edit button 421, the duplicate button 422, and the delete button 423 will be referred to as “input button(s) 420” unless otherwise specified. The details/edit button 421 is a button that implements a function of displaying details of paper information and rendering it editable. The duplicate button 422 is a button that enables duplication and saving of paper information selected from the paper information list 404. Specifically, in a case where the duplicate button 422 is pressed, a name registration window 601 in FIG. 6 is displayed to accept input of a name. Then, the paper information selected from the paper information list 404 is duplicated, changed to the input name, and saved as a user-set paper. For example, the duplicate button 422 functions such that, in a case where the paper selected from the paper information list 404 is a base paper and the duplicate button 422 is pressed, the paper information corresponding to the base paper is duplicated and then made editable. Incidentally, in a case where the paper information selected from the paper information list 404 is duplicated, the favorite information will not be taken over. The delete button 423 is a button that implements a function of deleting paper information. Note that an OK button 402 on the lower right side of the management-setting window 401 is a button that implements a function of notifying the system that operations on the details/edit button 421, the duplicate button 422, and the delete button 423 are finished. Also, in a case where the user operates the management-setting window 401 in FIGS. 4A and 4B, the input unit 303 in FIG. 3 detects the user's operation, and notifies the control unit 301 in FIG. 3 of the operated position (referred to also as “coordinates”) on the screen of the operation unit 212 in FIG. 2. The control unit 301 in FIG. 3 interprets which input button 420 was operated from the bitmap on the screen displayed on the operation unit 212 in FIG. 2 and the coordinates mentioned above, and performs a process corresponding to that input button 420. Thereafter, the control unit 301 in FIG. 3 generates a screen to be displayed next and notifies the display unit 302 in FIG. 3 of its content. A process corresponding to the user's operation is performed as described above, and the screen on the operation unit 212 in FIG. 2 transitions according to the corresponding operation mode.

### Base Papers and User-set Papers

Next, the base papers and the user-set papers will be described. The base papers and the user-set papers are each an indicator specifying the type of a paper. Paper information is set for each of these paper types. The paper information includes one or more setting values. Examples of the items specified by the setting values include the name, type, surface property, and color of the paper and information specifying adjustment of the secondary transfer voltage for the paper. These setting values relate to the image quality of images to be formed on the paper.

### Setting Values

Of the items specified by the setting values, examples of the name of the paper include “Thin Paper 1”, “Plain Paper 1”, and “Thick Paper 1”. More specifically, plain paper is, for example, an uncoated paper with a rough surface. Other examples include high-quality paper, mat paper, and gloss paper. The high-quality paper is an uncoated paper with a good surface property. The mat paper is a coated paper with a non-glossy surface. The gloss paper is a coated paper with a glossy surface. Also, in a case where there are multiple types of plain paper, numbers may be assigned as suffixes in the order of registration as “Plain Paper 1”, “Plain Paper 2”, and so on. Examples of the multiple types of plain paper include sheets of a plain paper with different sizes, such as such as A4 plain paper and A3 plain paper. Also, the plain paper 1 and the plain paper 2 may be, for example, papers with different basis weights.

Of the items specified by the setting values, the type of the paper represents the paper type at the time of editing on the paper information list 404. For example, of the paper types, a base paper represents a set of default setting values registered in advance as the paper information of a paper assumed to be used, such as plain paper or high-quality paper, at the time of shipping the product. Each base paper is registered as a set of default setting values in the image processing apparatus 103. Thus, each base paper is set to be uneditable. For this reason, in a case of editing paper information specified as a base paper, the base paper is duplicated. The duplicated base paper is provisionally registered in the RAM 202 or the HDD 204 by the paper information management unit 304 as temporary user-set paper (referred to also as “temporary user information” or “provisional paper information”) until its paper information is registered. In a case where the temporary user-set paper thus provisionally registered is finally registered by the paper information management unit 304, the temporary user-set paper is registered as a user-set paper (new paper information). That is, each user-set paper is presented as a base paper duplicated to be a temporary user-set paper and then edited and registered thereafter. Incidentally, in a case where a user-set paper is selected from the paper information list 404 and the details/edit button 421 is pressed, no temporary user-set paper will be generated.

### Editing Mode: Paper Information

In a case where, for example, the user selects the paper type selection drop-down list 411 in FIG. 4A, selects “Base Papers” out of the options 413, and then operates the details/edit button 421, the screen transitions to one on which the paper information can be edited. FIG. 5 is a diagram illustrating an example of a screen in an editing mode displayed on the operation unit 212. FIG. 5 illustrates an example in which an editing window 501 is displayed in a case where the operation mode is in the editing mode. The editing window 501 include the name, type, basis weight, surface property, and color of a paper and information specifying adjustment of the secondary transfer voltage for the paper as items specified by setting values. Of these, the basis weight, surface property, and color of the paper and the information specifying adjustment of the secondary transfer voltage for the paper will be referred to also as “the parameters of the paper”. At the right end of each of items specified by respective multiple setting values, a change button 502 or 503 is displayed as a button for changing the item specified by the setting value. Operating any one of the multiple change buttons 502 and 503 will cause the screen to transition to a corresponding setting value change screen. The setting value change screen accepts a change to the setting value (editing content) of a given item (editing target), and the changed setting value is saved (updated). Note that no change button 502 or 503 is displayed for the type of the paper, as illustrated in FIG. 5 because this is uniquely determined by the operation on the management-setting window 401 in FIGS. 4A and 4B, and the type of the paper is not to be changed by the user. Also, a next button 504 and a previous button 505 only need to be operable in a case where the parameters of the paper cannot be displayed at once in the editing window 501.

### Editing Mode: Add Favorite Button 506

In the editing window 501, the add favorite button 506 is displayed. The add favorite button 506 is a button that issues an instruction to register or unregister a favorite. In a case where the editing window 501 is displayed for the first time after the details/edit button 421 is operated, the add favorite button 506 is displayed in an on or off state according to the item selected from among the options 413 in FIG. 4B. For example, the add favorite button 506 in the on state may be displayed in a given color (such as yellow). The add favorite button 506 in the off state may be displayed with no color (the same color as the background color). Operating the add favorite button 506 switches its display state (on/off). Specifically, in a case where “Favorites” is selected from among the options 413, the add favorite button 506 is turned to the on state, and the paper information of a base paper or a user-set paper registered as a favorite is displayed in the editing window 501. In a case where “Base Papers”, “User-set Papers” or “All” is selected from among the options 413 and a favorite is associated with the selected item, the add favorite button 506 is turned to the on state. On the other hand, in a case where “Base Papers”, “User-set Papers” or “All” is selected from among the options 413 and no favorite is associated with the selected item, the add favorite button 506 is turned to the off state. In case where the add favorite button 506 in the on state is operated, the favorite may be unregistered. On the other hand, in a case where the add favorite button 506 in the off state is operated, a favorite may be registered. Note that an OK button 507 is disposed on the lower right side of the editing window 501. Operating the OK button 507 will save a setting value indicating the registration or unregistration with the add favorite button 506. Operating the OK button 507 will also save the editing content obtained by editing the editing target.

### Name Editing Mode

In a case where the change button 502 corresponding to the name of the paper among all items is operated, a setting value change screen for editing the name is displayed. FIG. 6 is a diagram illustrating an example of a screen in a name editing mode as the setting value change screen for editing the name. FIG. 6 illustrates an example in which the name registration window 601 is displayed in a case where the operation mode is in the name editing mode. The name registration window 601 represents a display example of the setting value change screen for editing the name. The name registration window 601 includes a keyboard for accepting a change to the name of the paper, an OK button 602, and a cancel button 603. In a case where the keyboard is operated and then the OK button 602 is operated, the input unit 303 in FIG. 3 stores the content of the keyboard operation as a new paper name. Specifically, in response to the operation on the OK button 602 in FIG. 6, the displayed screen returns to the editing window 501 from the name registration window 601. Thereafter, the input unit 303 in FIG. 3 detects the operation on the OK button 507 in FIG. 5. In response to this, the control unit 301 in FIG. 3 changes the name represented by the setting value, stores the changed name in the paper DB 305 with the paper information management unit 304 in FIG. 3, and returns the operation mode to the management-setting mode in FIGS. 4A and 4B. In the management-setting mode in FIGS. 4A and 4B, while illustration is omitted, the newly registered paper information is displayed in the paper information list 404. On the other hand, in a case where the keyboard is operated and then the cancel button 603 is operated, the input unit 303 in FIG. 3 discards the content of the keyboard operation, and the control unit 301 in FIG. 3 switches the operation mode back to the screen in the management-setting mode in FIGS. 4A and 4B. For instance, in the example of FIG. 6, a character string “Customized Thin Paper” is input. Thereafter, in a case where the OK button 602 in FIG. 6 is operated and the OK button 507 in FIG. 5 is operated, the content of the operation (referred to also as “editing content”) is stored. In a case where the cancel button 603 is operated, the content of the operation (referred to also as “editing content”) is discarded. Specifically, in a case where the change button 502 corresponding to the name of the paper is operated, the name can be edited. As a result, the paper will be distinguishable from other papers based on the edited paper name.

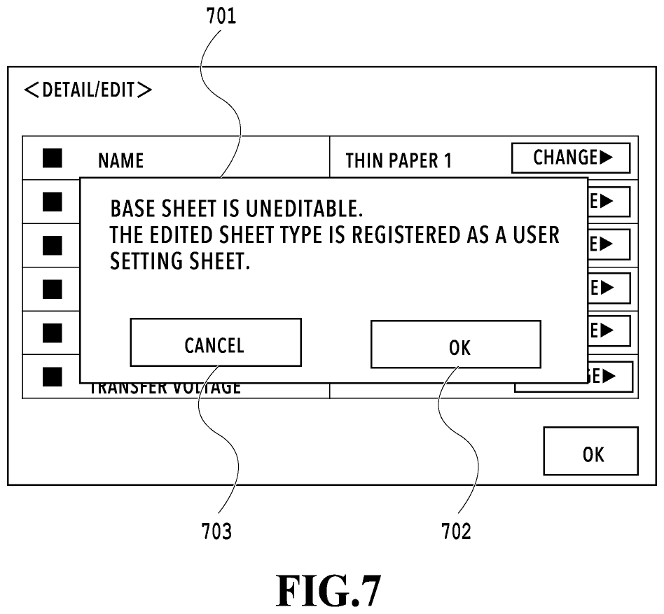

The description now returns to FIG. 5. In a case where the change button 502 or 503 is operated, the setting value is changed, and the OK button 507 is pressed, an editing screen in FIG. 7 for changing paper information is displayed. FIG. 7 is a diagram illustrating an example of a screen in an editing mode as an editing screen for changing paper information. FIG. 7 illustrates an example in which an editing prohibition notification window 701 is displayed in a case where the operation mode is a base paper editing mode. In the example of FIG. 7, the editing prohibition notification window 701 is displayed as a pop-up screen (notification) for choosing whether to register the changed setting value as new paper information. In the notification region in the editing prohibition notification window 701, a notification “Base paper is not editable. The edited paper type will be registered as a user-set paper.” is displayed. A cancel button 703 is displayed on the lower left side of the notification region of the editing prohibition notification window 701. An OK button 702 is displayed on the lower right side of the notification region of the editing prohibition notification window 701. In a case where the input unit 303 in FIG. 3 detects an operation on the cancel button 703, the control unit 301 in FIG. 3 switches the operation mode back to the screen in the management-setting mode in FIGS. 4A and 4B without saving the setting value.

On the other hand, in a case where the input unit 303 in FIG. 3 detects an operation on the OK button 702, the control unit 301 in FIG. 3 changes the setting value and then stores it in the paper DB 305 with the paper information management unit 304 in FIG. 3. Thereafter, the control unit 301 in FIG. 3 switches the operation mode back to the screen in the management-setting mode in FIGS. 4A and 4B. While illustration is omitted, the newly registered paper information is displayed in the paper information list 404 in FIGS. 4A and 4B. Note that the control unit 301 in FIG. 3 duplicates the base paper to create a temporary user-set paper. After the temporary user-set paper is created and registered, the type of the paper is changed to a user-set paper. Thus, the type of the paper is displayed as the user-set paper. Also, the type of the paper may be displayed as the base paper until its paper information is edited and changed.

### Basis Weight Editing Mode, Surface Property Editing Mode, Color Editing Mode, and Secondary Transfer Voltage Editing Mode

The description now returns to FIG. 5. In a case where the change button 503 corresponding to the basis of the paper weight among all items is operated, the operation mode shifts to a basis weight editing mode, and a setting value change screen for editing the basis weight of the paper is displayed. Here, the basis weight represents the weight of the paper per unit area. In the present embodiment, g/m² (grams per square meter) is used, but another unit may be used. For example, a ream weight may be used. The ream weight represents the weight of 1000 sheets of the paper. Alternatively, in a case where the change button 503 corresponding to the surface property of the paper among all items is operated, the operation mode shifts to a surface property editing mode, and a setting value change screen for editing the surface property of the paper is displayed. Here, the surface property represents the surface roughness of the paper. In the example of FIG. 5, “High-quality Paper” is presented as the surface property of the paper. Alternatively, “Plain Paper” may be presented as the surface property of the paper. Still alternatively, “Recycled Paper” may be presented as the surface property of the paper. Incidentally, while a paper with a basis weight of 90 g/m² is generated handled as thick paper, the surface of thick paper or plain paper is usually processed to be plain. Thus, “High-quality Paper” or the like can be presented as the surface property of the paper. In a case where the change button 503 corresponding to the color of the paper among all items is operated, the operation mode shifts to a color editing mode, and a setting value change screen for editing the color of the paper is displayed. In the example of FIG. 5, “white” is presented as the color of the paper. Incidentally, in the present embodiment, a name representing a general color, such as white, red, or blue, is designated but another color, such as one in DIC (a color sample book issued by DIC Corporation) or the like, may be used as long as it is distinguishable from other colors. In a case where the change button 503 corresponding to the information specifying adjustment of the secondary transfer voltage for the paper among all items is operated, the operation mode shifts to a secondary transfer voltage editing mode, and a setting value change screen for adjusting the secondary transfer voltage for the paper is displayed.

### Operation Example

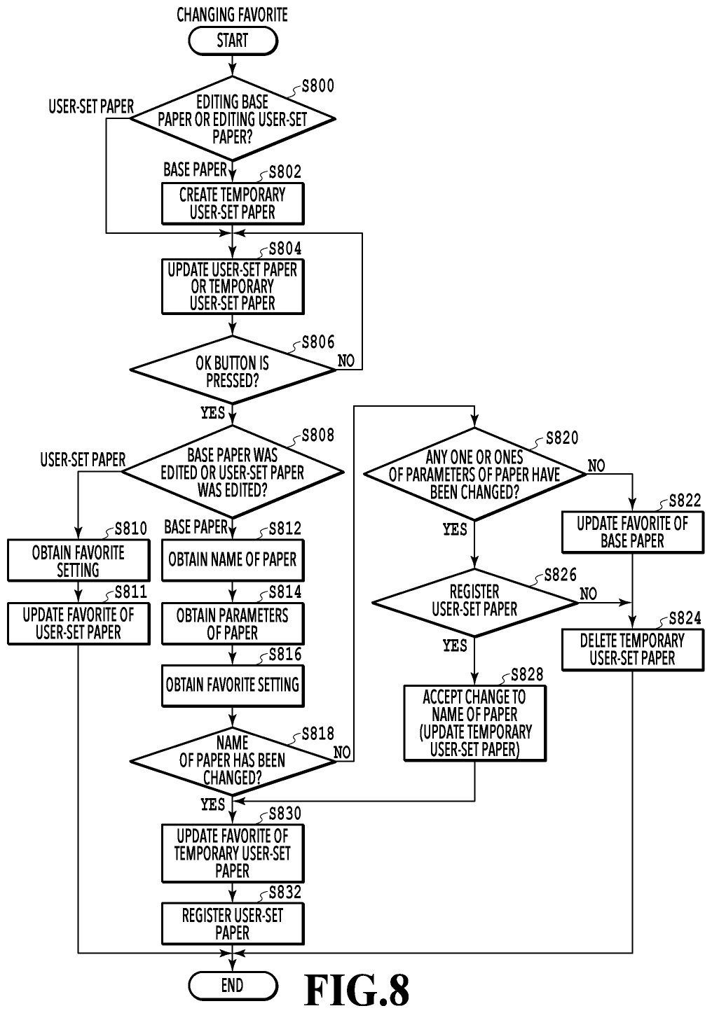

Next, an example of an operation of editing paper information and registering a favorite will be described. FIG. 8 is a flowchart illustrating an example of a process of editing paper information and registering a favorite. In FIG. 8, whether the editing target paper is base paper or user-set paper is determined. In a case where the editing-target paper is a user-set paper, the favorite of the user-set paper is updated. Here, updating the favorite means changing an editing content before editing to an editing content after the editing and storing the editing content after the editing in the RAM 202 or the HDD 204 with the paper information management unit 304. For example, updating the favorite of a user-set paper refers to an operation of changing the favorite of the user-set paper from an editing content before editing to an editing content after the editing and storing the editing content after the editing in the RAM 202 or the HDD 204. Note that the content stored in the RAM 202 may be stored in the HDD 204 as necessary. Here, editing paper information refers specifically to editing a setting value or setting values forming the paper information. Also, the editing content includes a change to the favorite in addition to a change to a setting value or setting values.

Also, in a case where the editing-target paper is a base paper, the operation will vary depending on the next determination. If it is determined that neither the name of the paper nor the parameters of the paper have been changed, the favorite of the base paper is updated. If it is determined that the name of the paper has been changed, a new paper type is registered based on the selected paper type with the changed favorite taken into account. Here, registering the type of a paper means storing paper information by paper type in the RAM 202 or the HDD 204 with the paper information management unit 304. Note that the content stored in the RAM 202 may be stored in the HDD 204 as necessary. Firmware for the process in FIG. 8 is stored in the HDD 204 of the image processing apparatus 103, and is loaded to the RAM 202 and executed by the CPU 201. Also, the flowchart of FIG. 8 starts in response to the control unit 301 accepting detection of an operation on the details/edit button 421 in FIGS. 4A and 4B by the input unit 303.

### Editing of Base Paper

In S800, the CPU 201 determines whether a base paper is selected or a user-set paper is selected in the management-setting window 401 in FIGS. 4A and 4B. If determining that a base paper is selected, the CPU 201 proceeds to S802. In S802, the CPU 201 duplicates the base paper to create a temporary user-set paper and proceeds to S804. Specifically, the CPU 201 duplicates the setting values included in the base paper. The CPU 201 provisionally registers the temporary user-set paper, which is for temporarily storing the duplicated setting values in the RAM 202 or the HDD 204, in the paper information management unit 304. Here, the CPU 201 also duplicates a favorite setting corresponding to the selected base paper together with the setting values. If, on the other hand, determining that a user-set paper is selected, the CPU 201 proceeds to S804. Here, as mentioned earlier, base papers and user-set papers are each an indicator specifying the type of a paper. Paper information is managed for each of these paper types. The paper information includes one or more setting values. The items specified by the setting values include the name, type, surface property, and color of the paper and information specifying adjustment of the secondary transfer voltage for the paper. These setting values influence the image quality of an image to be formed on the paper. Meanwhile, in a case of editing the paper information of a base paper, a temporary user-set paper is created by duplicating the base paper and will be used until the edited paper information is registered.

In S804, if a user-set paper was selected and the CPU 201 accepts a change to the name or a parameter or parameters of the paper, the CPU 201 updates the paper information of the user-set paper and proceeds to S806. In S804, if a base paper was selected and the CPU 201 accepts a change to the name or a parameter or parameters of the paper, the CPU 201 updates the temporary user-set paper, which is a duplicate of the base paper, and proceeds to S806. Here, as mentioned earlier, the parameters of the paper refer to the basis weight, surface property, and color of the paper and information specifying adjustment of the secondary transfer voltage for the paper among the items specified by the setting values.

In S806, the CPU 201 determines whether the OK button 507 is operated. If determining that the OK button 507 is operated, the CPU 201 proceeds to S808. On the other hand, if determining that the OK button 507 is not operated, the CPU 201 returns to S804. In S808, the CPU 201 determines whether a base paper or a user-set paper was selected on the management-setting window 401 in FIGS. 4A and 4B. If determining that a base paper was selected, the CPU 201 proceeds to S812. If, on the other hand, determining that a user-set paper was selected, the CPU 201 proceeds to S810. Note that the favorite information in the case where it is determined in S806 that the OK button 507 is operated is the favorite information represented by the editing content.

### User-set Paper

In S810, the CPU 201 obtains the setting value of the add favorite button 506 associated with the user-set paper. In S811, the CPU 201 updates the setting values of the favorite of the user-set paper according to the setting value of the add favorite button 506 obtained in S810, and terminates the process of this flowchart. Here, the setting value of the add favorite button 506 in the state where the add favorite button 506 is turned on is information indicating a state where the favorite setting is enabled. On the other hand, the setting value of the add favorite button 506 in the state where the add favorite button 506 is turned off is information indicating a state where the favorite setting is disabled. Note that the setting value of the add favorite button 506 may include paper information corresponding to the state where the favorite setting is enabled. Note that the paper information corresponding to the state where the favorite setting is enabled is such that a paper ID corresponding to the state where the favorite setting is enabled may be obtained to obtain paper information associated with the paper ID.

### Base Paper

In S812, the CPU 201 obtains the name of the paper. Here, the name of the paper is, for example, a name such as “Thin Paper 1”, “Plain Paper 1”, or “Thick Paper 1” as illustrated in FIG. 4A. Specifically, the CPU 201 obtains “Thin Paper 1”, which is a value corresponding to the name of a paper held in the editing window 501. In S814, the CPU 201 obtains the parameters of the paper. In S816, the CPU 201 obtains the setting value of the add favorite button 506 associated with the base paper. In S818, the CPU 201 determines whether the name of the paper obtained in S812 has been changed from the name of the duplicate-source base paper. If determining in S818 that the name of the paper has been changed from the name of the duplicate-source base paper, the CPU 201 proceeds to S830. On the other hand, if determining that the name of the paper has not been changed from the name of the duplicate-source base paper, the CPU 201 proceeds to S820. In S820, the CPU 201 determines whether any one or ones of the parameters of the paper obtained in S814 have been changed from the corresponding one or ones of the parameters of the duplicate-source base paper. If determining that any one or ones of the parameters of the paper have been changed from the corresponding one or ones of the parameters of the duplicate-source base paper, the CPU 201 proceeds to S826. On the other hand, if determining that none of the parameters of the paper has not been changed from the corresponding one of the parameters of the duplicate-source base paper, the CPU 201 proceeds to S822. In S822, the CPU 201 updates the setting values of the favorite of the base paper according to the setting value of the add favorite button 506 obtained in S816. In S824, the CPU 201 deletes the temporary user-set paper duplicated in S802 and terminates the process.

In S826, the CPU 201 displays the editing prohibition notification window 701 and determines whether to register the paper as a user-set paper. If detecting an operation on the OK button 702, the CPU 201 determines that the paper is to be registered as a user-set paper, and proceeds to S828. On the other hand, if detecting an operation on the cancel button 703, the CPU 201 determines that the paper is not to be registered as a user-set paper, and proceeds to S824. In S828, the CPU 201 displays the name registration window 601 and accepts a change to the name of the paper. If detecting an operation on the OK button 602, the CPU 201 updates the name of the temporary user-set paper. In S830, the CPU 201 updates the setting values of the favorite of the temporary user-set paper according to the setting value of the add favorite button 506 obtained in S816. In S832, the CPU 201 detects completion of the changing of the setting values in the editing window 501 in FIG. 5, registers the temporary user-set paper as a user-set paper in the paper information management unit 304, and terminates the process.

### Advantageous Effect of Operation

As described above, in a case of editing the paper information of a base paper and registering a favorite, the favorite of the base paper is updated in S822 if neither the name of the paper nor the parameters of the paper have been changed. Also, if the name of the paper has been changed, the favorite of the temporary user-set paper duplicated from the base paper is updated in S830, and the temporary user-set paper is registered as a user-set paper in the paper information management unit 304 in S832. In this way, in a case of registering a new paper, the favorite of a base paper or a user-set paper can be appropriately changed according to whether the paper type setting is changed. Hence, it is possible to improve the operability for registration of a favorite. Accordingly, it is possible to reduce the time and effort required to perform a data search for performing printing suitable for a paper.

### Second Embodiment

In the first embodiment, a description has been given of an example of a process of editing paper information and registering a favorite. In a second embodiment, a description will be given of an image processing apparatus 103 that notifies of which paper type's favorite setting has been updated after a series of operations for editing paper information and registering a favorite is completed. Notifying of which paper type's favorite setting has been updated enables the user to recognize the type of the paper whose favorite setting has been updated, and thus improves the operability for registration of a favorite. Note that, in the description of the present embodiment, the difference from the first embodiment will be set forth.

### Operation Example

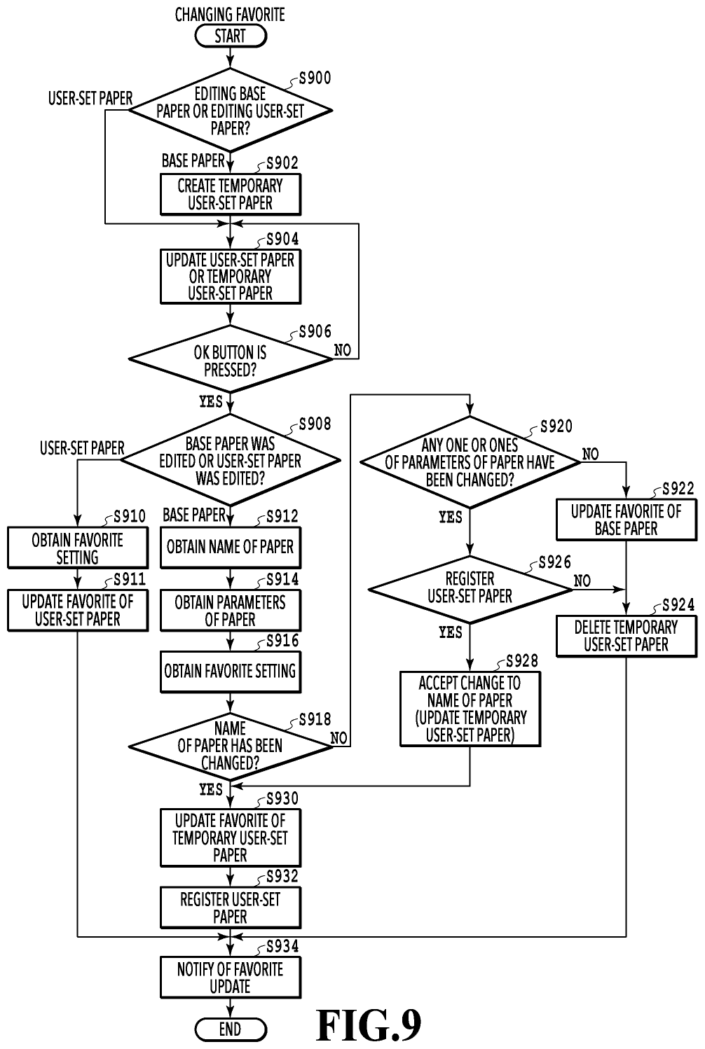

FIG. 9 is a flowchart illustrating an example of a process of editing paper information and registering a favorite. In the flowchart of FIG. 9, whether the editing-target paper is a base paper or a user-set paper is determined and, in a case where the editing-target paper is a user-set paper, the favorite of the user-set paper is updated. In a case where the editing-target paper is a base paper, the favorite of the base paper is updated if the name of the paper and the parameters of the paper have not been changed. If the name of the paper has been changed, a new paper type is registered based on the selected paper type with the changed favorite taken into account. The last operation involves notifying of which paper type's favorite setting has been updated. Firmware for the process in the flowchart of FIG. 9 is stored in the HDD 204 of the image processing apparatus 103, and is loaded to the RAM 202 and executed by the CPU 201. Also, the flowchart of FIG. 9 starts in response to the control unit 301 accepting detection of an operation on the details/edit button 421 by the input unit 303, as described earlier.

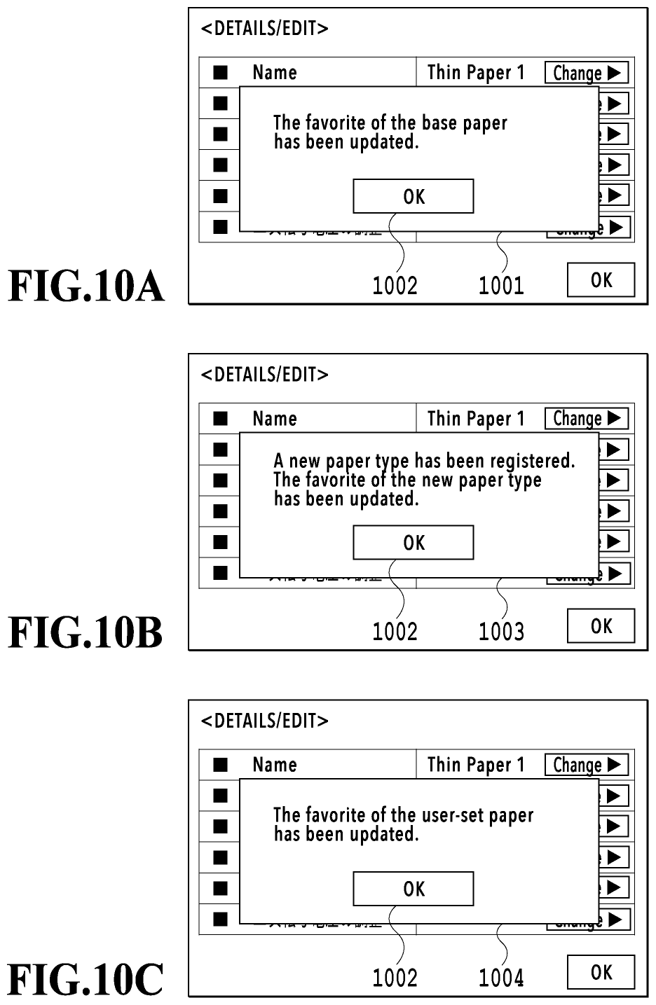

Note that S900 to S932 are equivalent to S800 to S832, and description thereof is therefore omitted. In S934, as will be described later using FIGS. 10A to 10C, the CPU 201 displays one of registration completion pop-up windows 1001, 1003, and 1004 to notify of the update of the favorite.

FIGS. 10A to 10C represent an example of the registration completion pop-up windows 1001, 1003, and 1004. FIG. 10A is the registration completion pop-up window 1001, which is displayed in a case where the favorite of a base paper is updated in S922. In the registration completion pop-up window 1001 is displayed a message indicating that the favorite of a base paper has been updated. In a case where the input unit 303 detects an operation on an OK button 1002, the control unit 301 switches to the management-setting window 401 in FIGS. 4A and 4B.

FIG. 10B is the registration completion pop-up window 1003, which is displayed in a case where the favorite of a temporary user-set paper is updated in S930. In the registration completion pop-up window 1003 is displayed a message indicating that a new paper type has been registered and the favorite of the new paper type has been updated. In a case where the input unit 303 detects an operation on the OK button 1002, the control unit 301 switches to the management-setting window 401 in FIGS. 4A and 4B.

FIG. 10C is the registration completion pop-up window 1004, which is displayed in a case where the favorite of a user-set paper is updated in S911. In the registration completion pop-up window 1004 is displayed a message indicating that the favorite of a user-set paper has been updated. In a case where the input unit 303 detects an operation on the OK button 1002, the control unit 301 switches to the management-setting window 401 in FIGS. 4A and 4B.

### Advantageous Effect of Operation

As described above, in S934 after completing a series of operations for editing paper information and registering a favorite, one of the registration completion pop-up windows 1001, 1003, and 1004 is displayed which indicates a message corresponding to the type of the paper whose favorite has been updated. This notifies of which paper type's favorite setting has been updated, thereby enabling the user to recognize the type of the paper whose favorite setting has been updated, and thus improving the operability for registration of a favorite.

### Other Embodiments

The above embodiments have been described based on examples using the term “favorite”. However, the present disclosure is not limited to these examples. The term may be changed to one that is easily usable for the user, such as “customized setting”, as appropriate.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-169556, filed Sep. 29, 2023, which is hereby incorporated by reference wherein in its entirety.

What is claimed is:

1. An image processing apparatus in which paper information is registrable, comprising:
a memory; and
a processor connected to the memory, wherein
the processor
sets predetermined information in the paper information,
registers the paper information, and
in the registration of the paper information, in a case where an operation capable of duplicating the paper information and registering new paper information is accepted and a name of the paper information is changed, sets the predetermined information in the new paper information and registers the new paper information based on the fact that the predetermined information is set in the paper information.

2. The image processing apparatus according to claim 1, wherein in the registration of the paper information, in a case where the operation capable of duplicating the paper information and registering new paper information is accepted and at least one of setting values of the paper information is changed, the processor sets the predetermined information in the new paper information and registers the new paper information based on the fact that the predetermined information is set in the paper information.

3. The image processing apparatus according to claim 1, wherein in the registration of the paper information, in a case where the operation capable of duplicating the paper information and registering new paper information is accepted and a setting value of the paper information is not changed, the processor sets the predetermined information in the paper information and registers the paper information based on the fact that the predetermined information is set in the paper information.

4. The image processing apparatus according to claim 1, wherein the operation capable of duplicating the paper information and registering new paper information is an operation of browsing a setting value of the paper information.

5. The image processing apparatus according to claim 1, wherein the predetermined information is at least favorite information.

6. The image processing apparatus according to claim 1, further comprising a generation unit that generates provisional paper information in a case where the operation capable of duplicating the paper information and registering new paper information is accepted and at least one of setting values of the paper information is changed, wherein
in a case where an operation of registering the provisional paper information is accepted, the processor registers the provisional paper information as the new paper information in the registration of the paper information.

7. The image processing apparatus according to claim 6, wherein
the processor further renders each of a plurality of setting values of the paper information editable, and
in the registration of the paper information, in a case where a name of a paper being one of the plurality of setting values is edited, the processor registers the provisional paper information with the name of the paper updated to the edited name of the paper as the new paper information.

8. The image processing apparatus according to claim 7, wherein in the registration of the paper information, in a case where at least one of a basis weight of the paper, a surface property of the paper, a color of the paper, and information specifying adjustment of a secondary transfer voltage for the paper as the plurality of setting values is edited by the editing unit, the processor registers the provisional paper information with the plurality of setting values updated to the edited plurality of setting values as the new paper information.

9. The image processing apparatus according to claim 6, wherein the processor further issues a notification indicating that the provisional paper information is to be registered as the new paper information.

10. The image processing apparatus according to claim 9, wherein the processor issues a notification prompting for selection of whether or not to register the provisional paper information as the new paper information in a case where the name of the paper information is not changed and at least one of the setting values of the paper information is changed.

11. A method of controlling an image processing apparatus in which paper information is registrable, the method comprising:
setting predetermined information in the paper information; and
registering the paper information, wherein
in the registering, in a case where an operation capable of duplicating the paper information and registering new paper information is accepted, the predetermined information is set in the new paper information and the new paper information is registered based on the fact that the predetermined information is set in the paper information.

12. A non-transitory computer-readable storage medium storing a program for causing a computer to execute:
setting predetermined information in paper information;
registering the paper information; and
in the registering, in a case where an operation capable of duplicating the paper information and registering new paper information is accepted, the predetermined information is set in the new paper information and the new paper information is registered based on the fact that the predetermined information is set in the paper information.
